(19) United States
(12) Patent Application Publication
(10) Pub. No.: US 2018/0142655 A1
(43) Pub. Date: May 24, 2018

(54) FUEL INJECTOR INCLUDING SENSOR

(71) Applicant: Delphi International Operations Luxembourg, S.A.R.L., Bascharage (LU)

(72) Inventors: David Thomas, Berkeley (GB); Mike Archer, Twickenham (GB); Cornelia Schulz, Herzogenaurach (DE); Florian Langguth, Nuremberg (DE)

(21) Appl. No.: 15/571,886

(22) PCT Filed: Mar. 21, 2016
(86) PCT No.: PCT/EP2016/056115

§ 371 Date: Nov. 6, 2017

(30) Foreign Application Priority Data
May 8, 2015 (GB) 1507858.7

(51) Int. Cl. F02M 57/00; F02M 51/00

(52) U.S. Cl. CPC F02M 57/005; F02M 51/005; F02M 2200/241; F02M 61/14; F02M 2200/8007; F02M 2200/85; F02M 2200/248

(57) ABSTRACT

A header for a fuel injector is connectable to a fuel injector main body, wherein the header includes a sensor adapted to measure one or more parameters of the fuel injector during operation thereof.

### CROSS REFERENCE TO RELATED APPLICATIONS

This application is a national stage application under 35 USC 371 of PCT Application No. PCT/EP2016/056115 having an international filing date of Mar. 21, 2016, which is designated in the United States and which claimed the benefit of GB Patent Application No. 1507858.7 filed on May 8, 2015, the entire disclosures of each are hereby incorporated by reference in their entirety.

### FIELD OF THE INVENTION

This disclosure relates to fuel injectors for engine systems of vehicles. It has particular but not exclusive application to fuel injectors which utilise sensors to provide parameters of operation of the fuel injector. These measured parameters can be processed and analysed to provide diagnostics of the operation or condition and other characteristics of the fuel injector. The parameters may alternatively be processed and analysed and subsequently used to control the operation of the fuel injector.

### BACKGROUND OF THE INVENTION

Fuel injectors are known to be equipped with various sensors such as “knock” sensors, pressure and temperature sensors which are located on or inside the fuel injectors to measure various parameters. So called knock (or vibration) sensors, which are effectively accelerometers with piezo-electric elements, are particularly useful in providing data ascertaining to fuel injector operation and can provide data such as the timing of valve events.

Such fuel injectors need to be designed to provide for such sensors and their connections. Usually the data are processed by, for example, an engine ECU. This means that there are design constraints on the injector when incorporating sensors.

### STATEMENT OF THE INVENTION

According to one aspect is provided a header for a fuel injector, said header being connectable to a fuel injector main body, wherein said header includes a sensor adapted to measure one or more parameters of the fuel injector during operation thereof.

The sensor may be an accelerometer or vibration sensor.

The sensor may be located adjacent to or integrated with the means for connecting said header to the fuel injector main body.

The sensor may be located at, or adjacent to, the interface of the header and fuel injector main body.

The sensor may be located within or integral with a mounting bush, said mounting bush adapted for locating said header to said injector main body.

The sensor may be encapsulated within said mounting bush.

The sensor may be formed as a washer shaped element.

The sensor or bush may be encapsulated within a main body of said header.

The header may include processing circuitry connected to said sensor adapted to process data from said sensor.

The header may include memory storage mean for storing data characteristic of the fuel injector, raw or processed sensor data.

The header may include connection means to supply processed or raw sensor data to an engine control or diagnostic unit.

In a further aspect is provided a fuel injector including a header as claimed in any preceding claim.

In another aspect therefore, is provided a fuel injector including a header portion connected or connectable to an injector main body portion, where said header portion includes a sensor to measure one or more parameters of the fuel injector during operation.

The sensor may be an accelerometer or vibration sensor.

The sensor may be located adjacent to or integrated with the means for connecting said header portion to said main body.

The sensor may be located at, or adjacent to, the interface of the header portion and main body.

The sensor may be located within or integral with a mounting bush, wherein said header portion is adapted to be fixed to said main body via said mounting bush.

The sensor may be encapsulated within said mounting bush.

The sensor may be formed as a washer shaped element.

The sensor or bush may be encapsulated within the main body of said header.

The header may include processing circuitry connected to said sensor adapted to process data from said sensor.

The header may include memory storage mean for storing data characteristic of the fuel injector, raw or processed sensor data.

The header may include connection means to supply processed or raw sensor data to an engine control or diagnostic unit.

### BRIEF DESCRIPTION OF DRAWINGS

The invention will now be described by way of example and with reference to the following figures of which:

FIGS. 1A and 1B show a schematic representation of a fuel injector;

FIG. 2 shows a header for a fuel injector;

FIG. 3 shows a fuel injector header according to examples of the invention;

FIG. 4 shows a fuel injector header according to a further example of the invention;

FIGS. 5A and 5B show the internal components of the FIG. 4 example;

FIGS. 6A, 6B, 6C, 7A, and 7C show examples of the design of the header according to examples of the invention;

FIGS. 8A and 8B shows cross sectional and plan views of the overmould design of the examples of FIG. 6.

### DETAILED DESCRIPTION OF INVENTIONS

### Prior Art

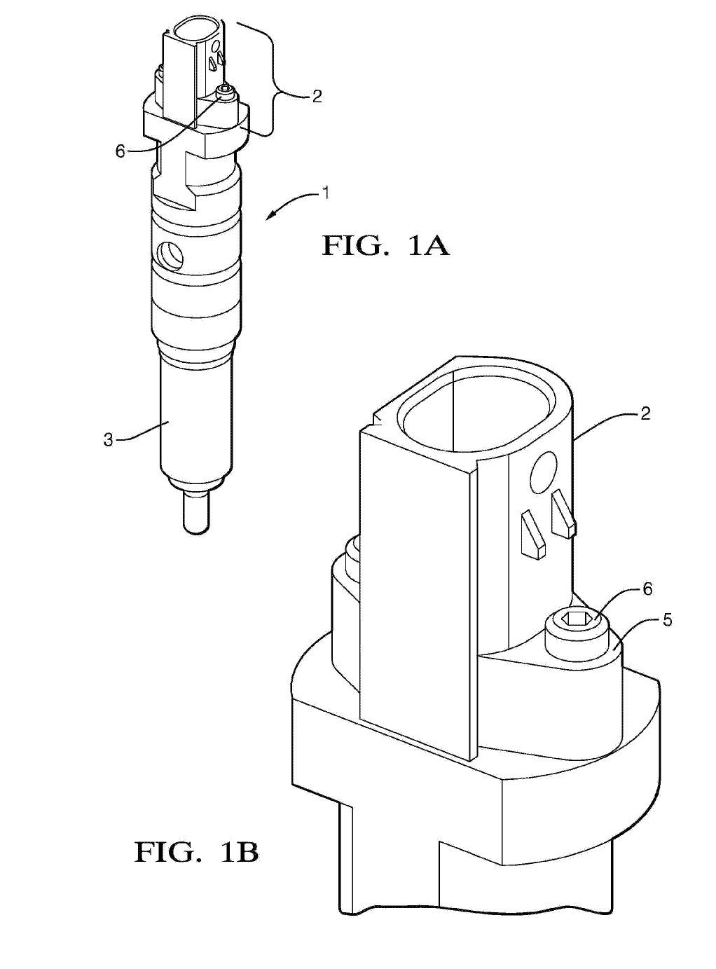

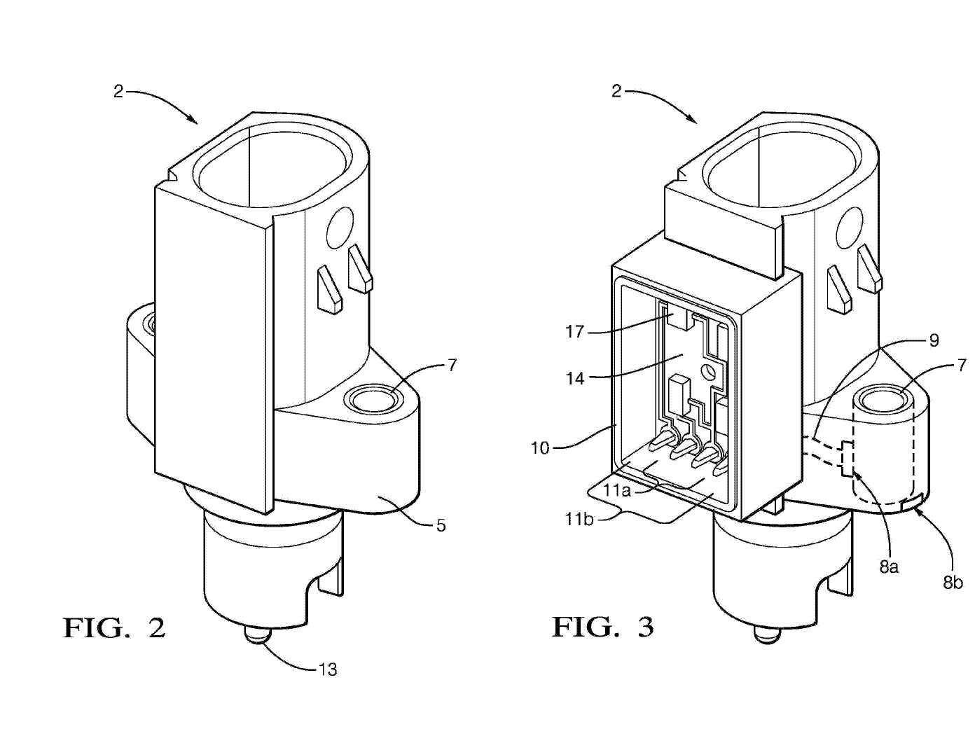

FIG. 1A shows a schematic representation of a fuel injector 1. It includes a main (e.g. body portion) 3 which includes a housing for an actuator and valve components (not shown). Generally speaking an electrical actuator such as a solenoid or piezo-electric actuated actuator is located within the injector body to actuate valve components so as to open and close a valve system in order to inject fuel under pressure into a combustion space. The actuators are supplied with electrical control (actuation) signals such as pulses via e.g. leads connectable to a head portion 2 via a pins or other connection means. The header portion 2 typically has further electrical connectivity with the main body of the fuel injector way of by pins 13 (see FIG. 2) adapted to slot into a socket arrangement in the main body. The header may be mechanically fixed to the injector by means of a screw or bolt means 6, via a flange 5 which includes a bush/tapping portion 7, as shown in more detail in FIG. 2.

A standard header on its own is shown in FIG. 2. This shows the flange portion 5 and the bush/tapping portion 7.

### DETAILED DESCRIPTION OF INVENTION

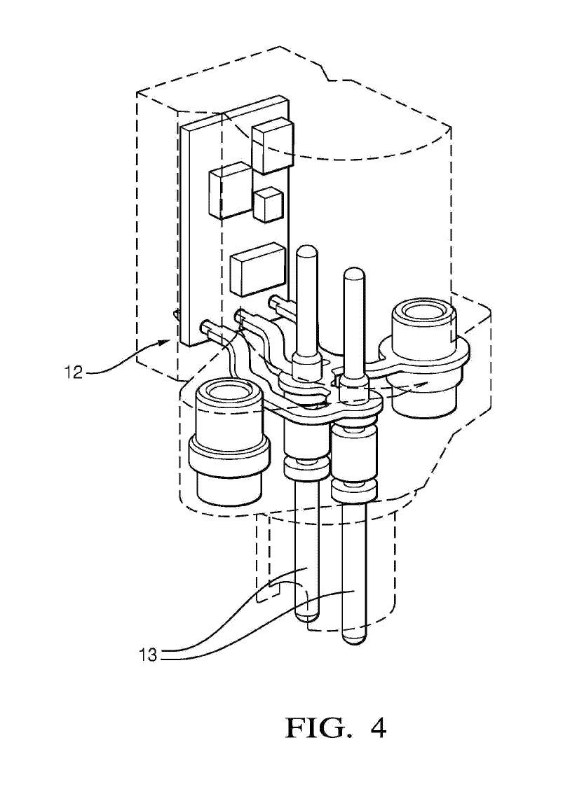

FIG. 3 shows an example of the invention. It shows again shows the header 2, which again includes the flange with bush 7 to receive a connection bolt/screw. Located on the header is a vibration sensor (accelerometer) or so called “knock sensor” 8a. This has a connection via e.g. leads to a header electrical connector socket 10. This socket usually has the two usual pins 11a (actuator terminals) for connection to the ECU/drive pulse circuit (via a connector which is not shown) in order to provide a drive pulse to the actuator in the main body via internal (with respect to the header) pins 13.

In an example of the invention the socket is provided with further connection means (via pins 11b) so as to connect the knock sensor to the ECU of the vehicle or any other suitable controller/device.

The header may be provided with a PCB 14 to which both the terminal pins 11b (optionally 11a) as well as knock sensor is electrically connected. The PCB may include circuitry (e.g. such as amplifiers) adapted to provide a signal form the sensor to the ECU or provide power to the sensor depending on type.

Preferably the accelerometer/knock sensor 8 is encapsulated within the header. The sensor is preferably located at the interface of the header and injector body (sensor 8b) and/or preferably adjacent to the bush (8a) or other connection means.

In the embodiment shown there are four pins 11 in the socket. As mentioned two 11a are for the purpose of providing electrical drive pulses to the injector actuator and the other two are terminal pins 11b from the knock sensor/accelerometer (via circuitry on the PCB).

In an alternative embodiment, there may be just two pins provided rather than four (pairs 11a and 11b), to both receive actuation signals from an ECU/controller as well as transmit accelerometer/sensor data to the ECU. Appropriate latching or switching circuits may be provided to selectively operationally connect the pins and thus the ECU, to either the injector actuator or the accelerometer. At the ECU the accelerometer signals can be analysed and used to provide diagnostic information or to adaptively control the injector.

The vibration sensor/accelerometer can be used for a number of purposes. In one particular application, data from the sensor can be used to detect valve events such as detection and measurement of nozzle valve events, nozzle control, valve outlet metering, spill valve and switching events. Other engine events (for example combustion, misfire, knock) can also be identified from the sensor waveform, allowing engine condition monitoring to be performed by the injector, with data passed to the ECU as described above, eliminating the need for additional knock sensors.

Preferably the vibration sensor/accelerometer is located integral with or adjacent to the bush or seating face as shown in options 8a or 8b in FIG. 3.

Other sensors such as temperature sensors may also be located on the header.

In enhanced embodiments, the header also includes microprocessor and/or memory devices such as an electronic chips and any associated circuitry. Such a microprocessor can analyse/process/store sensor data; this will be described in more detail hereinafter.

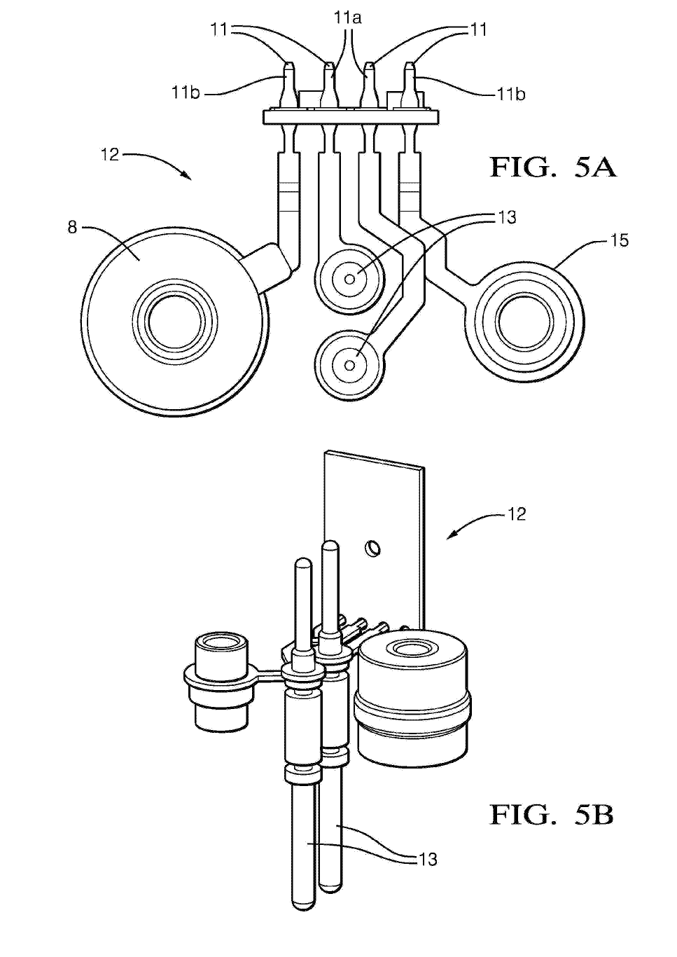

FIG. 4 shows a header of a fuel injector header 2 according to one example. The broken line shows the outline of the header and the remaining internal portion 12 schematically shows the internal components within the header. The internal components are preferably encapsulated in a header main block which may be formed of plastic, ceramic or other material.

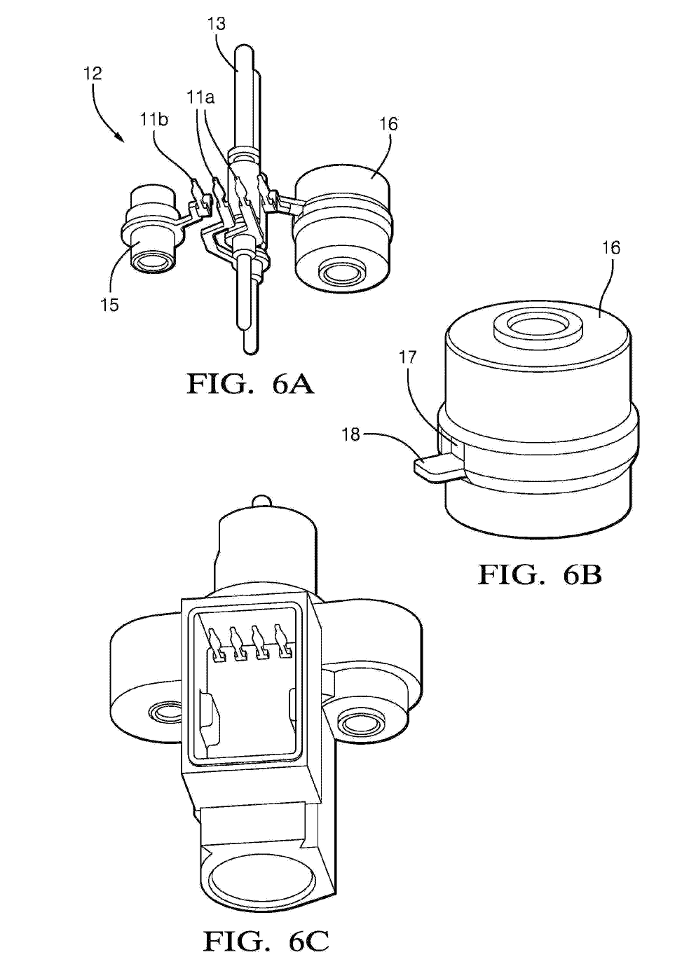

The internal arrangement (portion) is shown separately in FIGS. 5A and 5B which show a plan and isometric view of the internal portion 12. The internal portion comprises two actuator electrical connecting pins 13 for connection to respective terminals within the injector body for supplying drive pulses to the injector actuator. These two connecting pins are connected to terminal pins 11a. There are two further terminal pins 11b; one of these connects (e.g. via the PCB) to an accelerometer/knock sensor formed integral with or part of a bush 16 and the other connects (via the PCB) to a grounding bush 15.

The bush 16 incorporating the sensor is preferably located/mounted coincident with the connection means of the header to the injector body e.g. by incorporating the within tapping 7. The sensor 8 may be incorporated within bush as a washer-shaped piezo element. By mounting integral with or adjacent to the mechanical connection means, provides that vibrations are better sensed due to the direct connectivity with the injector body. So sensing vibrations in the injector body resulting from valve events is enhanced.

The ground terminal 15 may be formed also as a bush, and is used to provide the ground for the vibration sensor via the injector body, and any other associated circuitry explained hereinafter such as a PCB.

In the above arrangement the signals form the sensor may be provided to the engine ECU for analysis.

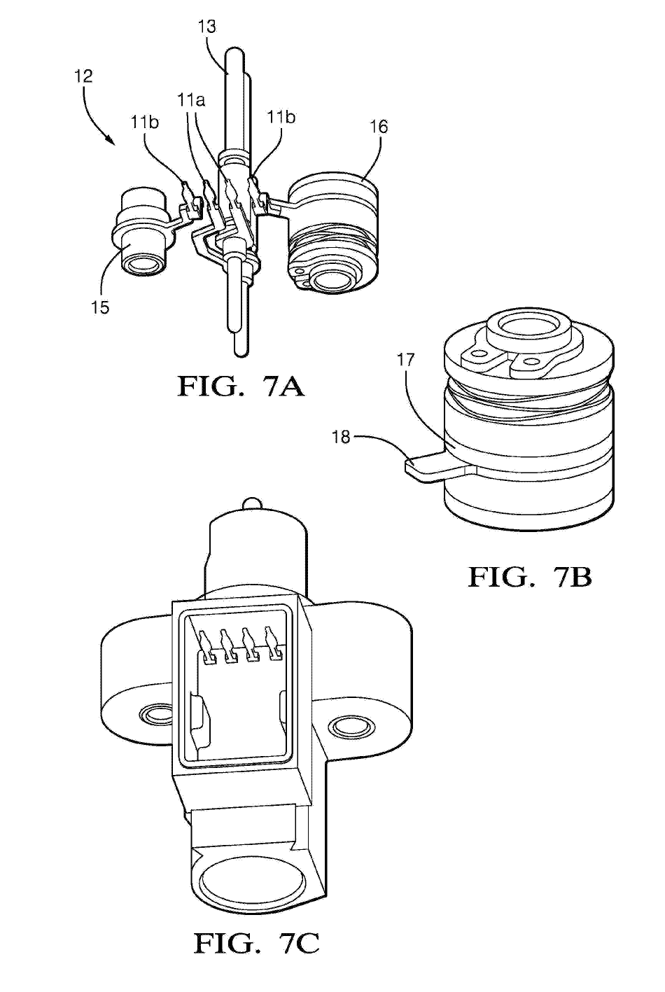

FIGS. 6A-6C and 7A-7C show alternative designs of the sensor and how they are incorporated within a header housing. FIGS. 6A and 7A show two options of the internal arrangement (and are similar to FIG. 5B) which shows the actuator electrical connecting pins 13, connected to the terminal pins 11a, the grounding bush 15 and a bush 16 incorporating/comprising the knock sensor includes the pin/terminal for these 11a to provide connection for the grounding bush and sensor connected thereto.

FIGS. 6B and 7B show the knock sensor incorporated into bush (structure) 16 in more detail in two variants. The knock sensor may be formed as a washer-shaped piezo element 17 and includes a connection tab 18; tab 18 projects from the bush for electrical connection. The element may be electrically insulated within the bush. In FIG. 6B the sensor is over-moulded within bush 16—so the sensor is encapsulated within a bush. FIG. 7B shows a non encapsulated sensor element again formed as a Piezo electric washer shaped element 17 sandwiched between insulating discs, the assembly of these forming part of the bush.

FIGS. 6C and 7C show how the whole assembly of FIGS. 6A and 7A are over-moulded to provide substantially the main body of the header.

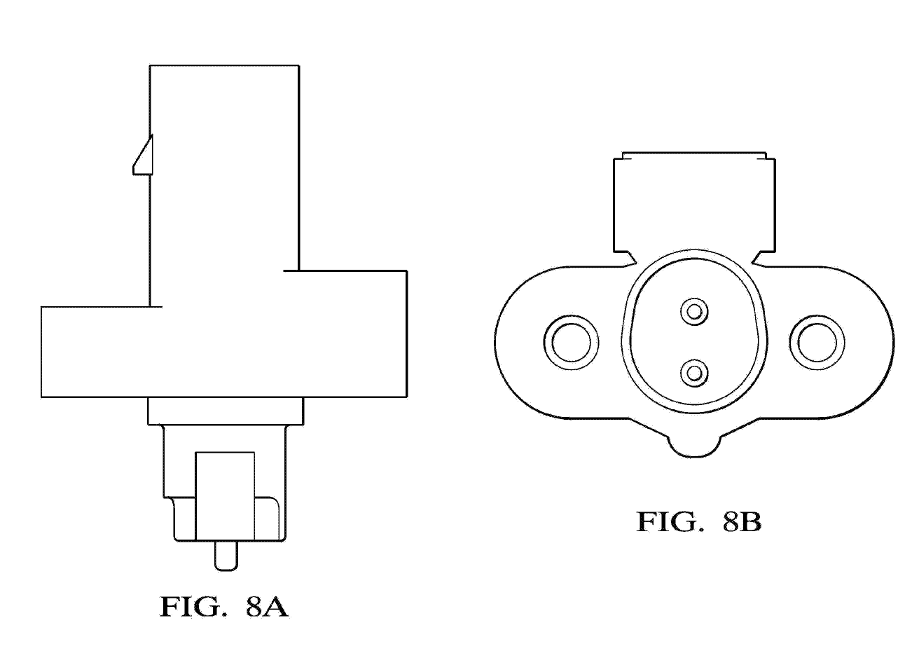

FIGS. 8A and 8B show cross sectional and plan views of the over-mould design of the examples of FIGS. 6A-6C and 7A-7C.

In an enhanced embodiment, the arrangement may also include a PCB 16 to on which is located circuitry including an electronic chip 17 (see FIG. 3) which has memory and/or processing functionality on a circuit board. Again this is attached or integral with a fuel injector header. So the chip may be attached to a printed circuit board which is attached to or within the housing of the header appropriately.

The chip may store data associated with the injector and may store individual injector data such as trim characteristics for sensor.

Alternatively and/or additionally, the chip may have processing capability; it may comprise a microprocessor allowing sensor data is processed. So data provided to the chip for processing by sensors is in one embodiment processed in a similar way to the processing done by the ECU as detailed above.

There may also be located on the PCB a memory storage device (such as RAM) to allow data (processed or raw data) to be written to/from the ECU, in order to provide diagnostic data for use in service, rework or warranty investigations. Injector build history may also be stored on the memory, thus again this located on the injector header.

Raw data or processed data (e.g. processed by the header chip) may be sent from the electronic circuitry (chip) in the header at convenient times to the engine ECU which in turn controls the actuation of the valve actuator dependent on the raw or processed data. Thus the sensor can be used to provide feedback control for the injector.

These measured parameters can be processed and analysed by the chip 17 to provide diagnostics of the operation or condition and characteristics of the fuel injector. The parameters may alternatively be processed and analysed used to control the operation of the fuel injector.

The data may be sent at a convenient time window. The beginning of the timing window can be established using the point at which negative voltage occurs at the end of the valve drive signal. In one embodiment the signal is received directly from the ECU to initiate the start of the window. As mentioned the communicated signal may take either an analogue or digital form. Analogue data may comprise a raw sensor trace passed to the ECU; it is preferably passed during the inactive window in between drive waveform signals. Digital data may be that where there is an option to store and process descriptive data on board the connector prior to transmission to the ECU.

In the case of a knock (vibration sensor), as well as gathering operational data, the use of a knock sensor allows wear characteristics can be monitored and compensated for. The sensor's output can be processed by the connector's integrated processor 17, allowing the detection and measurement of fuel injection events and the movement or operation of a nozzle valve, nozzle control valve, outlet metering valve, spill valve, etc. as well as switching events. The timing of these events can be used to precisely characterize injector and fuel injection equipment behavior. The processed data/characteristics can be and compared to historic injector data held either within the ECU or the memory storage device on the chip, to detect changes. This allows for the adjustment of the drive waveforms supplied to the injector from the ECU to ensure consistent behavior. Ultimately, the ability to measure injector valve events in real time may facilitate closed loop “trimming” of injector performance, reducing factory testing and calibration costs, and improving cylinder to cylinder variation on engine.

The processed data can be used to provide “early warning” to ECU that detect a change in behavior and alert the driver to a service requirement before “limp-home mode” is required. This data may be transmitted in operation during the inactive periods in between actuator drive pulses.

Similarly a temperature sensor or indeed any sensor may be included within the header to provide engine temperature monitoring.

By incorporating/integrating sensors onto or within the header this means the geometry and method of electrical connection to mating fuel injection equipment components and ECU harness connectors is maintained. All additional electrical connections between PCB, pins and sensor are preferably encapsulated within the connector. Push fit connections are preferably to limit the amount of welded connections required. This means that it can be introduced into the assembly process line without requiring investment in new assembly, connection or injection molding technologies. The existing mounting geometry is also preserved, allowing introduction of this new technology without impacting engine or injector design. Additionally, existing injectors can be upgraded without a change to the geometry of other components.

1. A header for a fuel injector, said header being connectable to a fuel injector main body, wherein said header includes a sensor adapted to measure one or more parameters of the fuel injector during operation thereof, wherein said sensor is located within or integral with a mounting bush in said header, said mounting bush adapted for locating said header to said fuel injector main body.

2. A header as claimed in claim 1 wherein said sensor is an accelerometer or vibration sensor.

3. A header as claimed in claim 1 wherein the sensor is located at, or adjacent to, an interface of the header for the fuel injector main body.

4. A header as claimed in claim 1 wherein said sensor is encapsulated within said mounting bush.

5. A header as claimed in claim 1 wherein said sensor is formed as a washer shaped element.

6. A header as claimed in claim 1 wherein said sensor or said mounting bush is encapsulated within a main body of said header.

7. A header as claimed in claim 1 wherein said header includes processing circuitry connected to said sensor adapted to process data from said sensor.

8. A header as claimed in claim 1 said header includes memory storage mean for storing data characteristic of the fuel injector, raw or processed sensor data.

9. A header as claimed in claim 1 wherein said header includes connection means to supply processed or raw sensor data to an engine control or diagnostic unit.

10. (canceled)

11. A fuel injector comprising:
a fuel injector main body; and
a header connected to said fuel injector main body, wherein said header includes a sensor adapted to measure one or more parameters of said fuel injector during operation thereof, wherein said sensor is located within or integral with a mounting bush in said header, said mounting bush adapted for locating said header to said fuel injector main body.
